(19) United States
(12) Patent Application Publication
(10) Pub. No.: US 2025/0361343 A1
(43) Pub. Date: Nov. 27, 2025

(54) POLYMER FOR FINISHING OF SUBSTRATES CONTAINING AMINO AND/OR AMIDE GROUPS

(71) Applicant: Rudolf GmbH, Geretsried (DE)

(72) Inventors: Dirk SIELEMANN, Geretsried (DE); Christoph HAUSER, Geretsried (DE); Rainer BRAUN, Bad Heilbrunn (DE)

(73) Assignee: Rudolf GmbH, Geretsried (DE)

(21) Appl. No.: 19/214,332

(22) Filed: May 21, 2025

(30) Foreign Application Priority Data
May 23, 2024 (EP) 24177551.9

(51) Int. Cl. C08F 212/08; C08F 6/02; C08K 5/5353; D06M 15/233; D06M 23/10; D06M 101/34

(52) U.S. Cl. CPC C08F 212/08; C08F 6/02; C08K 5/5353; D06M 15/233; D06M 23/10; D06M 2101/34; D06M 2200/25; D10B 2331/02

(57) ABSTRACT

The present invention relates to a partially neutralized polymer, a method for its production and its use for the finishing of substrates.

### CROSS-REFERENCE TO RELATED APPLICATIONS

This application claims the benefit of European Patent Application No. 24177551.9 filed on May 23, 2024, the disclosure of which is incorporated herein in its entirety by reference.

### DESCRIPTION

The present invention relates to a partially neutralized polymer, a method for its production and its use for the finishing of substrates.

Dyed and printed textiles often exhibit an unsatisfactory color fastness. “Color fastness” refers to the resistance of the coloring to external influences such as water, light, or friction. This is particularly the case with colorings with anionic dyes such as acid dyes, pre-metallized dyes or metal complex dyes and, to a lesser extent, with reactive dyes or reduction dyes.

Many substrates that are dyed with anionic dyes contain amino or amide groups and are of synthetic or natural origin, such as polyamides or polyamide blends, wool, silk, imitation leather, or leather.

The anionic dye is bound to the substrate by an ionic bond. However, this bond is relatively weak and can cause fastness issues.

To ensure color fastness after dyeing, agents are used that enable and promote stable anchoring of the dye molecules on the fibers and thereby reduce the likelihood of color loss during wear or washing.

Color fastness enhancers have been known for a long time. They form ionic bonds with the amino groups of the fibers and create a surface layer, causing the diffusion of the dye from the treated fiber to be reduced.

Well-known post-treatment agents are, e.g., so-called “syntans,” i.e., condensation products of aromatic sulfonic acids and formaldehyde (derivatives). The word “syntan” is a composition of “synthetic” and “tannin,” since natural tannins and/or tartar emetic were originally used as post-treatment agents for anionically dyeable fibers.

Sulfonated condensation products of phenol, naphthol, bisphenol such as bisphenol A or bisphenol S are also used as color fastness enhancers.

WO 94/28231 describes sulfonated naphthol-and phenol-formaldehyde condensation products, respectively, as post-treatment agents for polyamides.

In U.S. Pat. No. 5,574,106 A, acrylic copolymers are disclosed which impregnate and impart stain resistance to nylon carpets and other polyamide products. No efficacy as color fastness enhancer is disclosed.

A disadvantage of these agents is that due to the phenolic constituents, the treated substrates tend to yellow from UV light, particularly sunlight.

Moreover, phenols, bisphenols, or formaldehyde are listed as SVHC (substances of very high concern) due to their harmfulness to health and lack of environmental friendliness and are increasingly undesirable.

To circumvent these problems, an environmentally friendly composition for anchoring of dyes is proposed in WO 95/30794. Although the problem of yellowing is solved by this composition, it does not provide sufficient wash and perspiration fastness.

The task of the present invention is therefore to overcome the disadvantages of the prior art.

Surprisingly, it was found that through the polymer or composition of the invention, the dye can be anchored strongly to a substrate and does not, or only minimally, come off or decolor even through perspiration, frequent washing, steaming, ironing, and/or mechanical friction. Neither discoloration due to light or UV radiation nor any yellowing are observed. Furthermore, the polymer or composition of the invention is free of substances that present health risks, such as phenol, bisphenol, or formaldehyde. The compositions according to the invention exhibit favorable flow and migration properties, good storage stability and good shear stability.

Without being bound by any theory, it is assumed that the dye molecules are anchored to the substrate by the polymer according to the invention essentially through hydrophobic and π interactions of the aromatic groups.

In one aspect, the invention is directed to a polymer comprising the repeating units

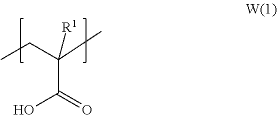

or a salt thereof,

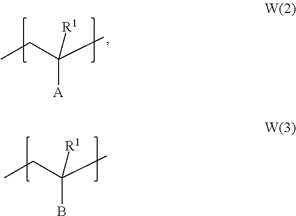

or a salt thereof,
and optionally

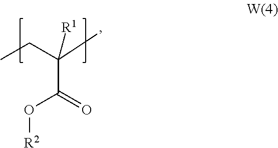

wherein
R¹ is independently-H, -aryl or -alkyl, particularly —CH₃ or —C₂H₅, preferably H;
R² is independently —C₂₋₈-alkyl or
-aryl optionally substituted with C₂₋₂₀-alkyl or C₂₋₂₀-alkenyl, or
—CH₂—CH₂—O-aryl optionally substituted with C₂₋₂₀-alkyl or C₂₋₂₀-alkenyl,
preferably-aryl;
A is independently an aryl group, particularly -phenyl, -tolyl, -xylyl, or -naphthyl, particularly preferably phenyl,
B is independently an aryl group, particularly -phenyl, -tolyl, -xylyl, or -naphthyl, particularly preferably phenyl, which is substituted with

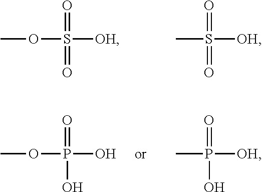

particularly with

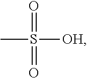

wherein at least 75 mol % of the repeating units W(1) and W(3) are present as at least monovalent salt, preferably as sodium salt.

Preferably, R¹ is H in each case.

A is preferably a phenyl group in each case.

B is preferably a phenyl group in each case, which is substituted with

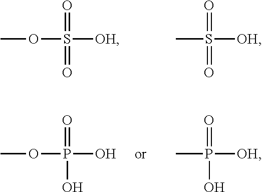

particularly with

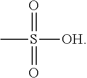

R² is preferably -aryl or —CH₂—CH₂—O-aryl substituted with C₂₋₂₀-alkyl or C₂₋₂₀-alkenyl in each case, more preferably -phenyl or —CH₂—CH₂—O-phenyl substituted with C₂₋₂₀-alkyl or C₂₋₂₀-alkenyl in each case.

In a preferred embodiment, R¹ in W(1), W(2), W(3) and W(4) is —H in each case, A is —phenyl in each case and B is substituted phenyl in each case, particularly phenyl substituted with —SO₃H.

At least 75 mol %, preferably 75-99.9 mol % of the repeating units W(1) and W(3) are present as at least monovalent salt, i.e. at least singly deprotonated, wherein the sum of W(1) and W(3) gives a total of 100 mol % (W(1)+W(3)=100 mol %).

The monovalent salt of the repeating unit W(1) is a carboxylate salt. Monovalent salts of the repeating unit W(3) are, e.g., sulfates, sulfonates, hydrogen phosphates or primary phosphonates. Bivalent salts of the repeating unit W(3) are, e.g., phosphates or secondary phosphonates. The salt-forming cations are independently preferably alkali metal ions or alkaline earth metal ions, particularly sodium ions.

It was surprisingly found that an excellent substantivity can be achieved in the claimed range of the salt group concentration in the polymer. Further, the viscosity of the polymer in aqueous solution can be significantly reduced compared to polymers in which the salt content is below the claimed range.

The beneficial effect of substantivity achieves outstanding color fastness, and the reduced viscosity facilitates the handling of the polymer in the form of solutions, particularly aqueous solutions.

The polymer preferably contains 40-80 mol %, more preferably 40-70 mol %, more preferably 40-60 mol % or more preferably 50-70 mol %, repeating units W(1), 5-50 mol %, more preferably 25-50 mol %, or more preferably 10-40 mol %, repeating units W(2), 1-20 mol %, more preferably 5-20 mol %, more preferably 7-20 mol % or 1-10 mol-%, preferably 1-8 mol % repeating units W(3) and 0-10 mol %, preferably 0-5 mol %, repeating units W(4) (with W(1)+W(2)+W(3)+W(4)=100 mol %).

Accordingly, the molar ratio W(1):W(2):W(3):W(4) is preferably 9-20:1-12:0.1-3:0-3, more preferably 4-6:2.5-5:0.5-2:0-1.

The polymer preferably contains 35-70 mol %, more preferably 40-70 mol %, even more preferably 50-70 mol % repeating units of W(2) and W(3) (W(2)+W(3)) with respect to all repeating units (W(1)+W(2)+W(3)+W(4)=100 mol %).

It was found that the nonpolar repeating units W(2) and W(3), each carrying an aryl group, engage in an excellent interaction with the dye molecules and stabilize them on the substrate. This effect is thought to be due to π-π interactions.

At the same time, the dispersibility of the polymers in aqueous media and their interaction with polar substrates, such as amide- and/or amino-containing substrates, can be adjusted via the molar proportions of the repeating units W(1) and W(3) and their degree of deprotonation (>75 mol % salt formation) without counteracting the above-described (desired) nonpolar interactions. The polymers of the invention are therefore surprisingly suitable for the uncomplicated finishing of polar substrates in aqueous media with excellent fastness results.

In a particularly preferred embodiment, the invention therefore relates to a polymer comprising the repeating units
W(1) or a salt thereof,
W(2),
W(3) or a salt thereof, and
optionally W(4),
   wherein at least 75 mol % of the repeating units W(1) and W(3) are present as at least monovalent salt, preferably as sodium salt, and
   wherein the polymer contains 40-70 mol % W(1), 25-50 mol % W(2), 5-20 mol % W(3) and 0-10 mol % W(4), with the proviso that the polymer contains 35-70 mol %, preferably 40-70 mol %, repeating units of W(2) and W(3) (W(2)+W(3)).

The polymer of the present invention is preferably water-soluble. Particularly, the polymer according to the invention is completely soluble at 100-600 g/L, preferably 200-300 g/L in distilled water at 20° C.

The pH value of a 30% solution in distilled water at 20° C. is preferably 6-7, preferably 6.2-6.5. A 30% solution in distilled water at 20° C. preferably has a viscosity of 50-1200 mPas, preferably 50-600 mPas, more preferably 100-300 mPas, measured according to DIN53019/ISO3219. The low viscosity facilitates easy processing and pumpability. The repeating units W(1), W(2), W(3) and optionally W(4) are preferably arranged statistically, alternately or in blocks in the polymer chain. Preferably, the polymer according to the invention is a statistical polymer.

Another aspect of the invention is a method for producing the polymer described above. The method comprises the steps of
(a) providing the monomers

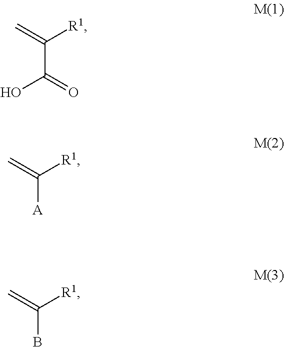

and optionally

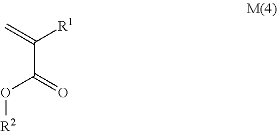

as solution or dispersion,
(b) polymerizing the mixture obtained after step (a),
(c) neutralizing the mixture obtained after step (b) so that at least 75 mol % of the repeating units W(1) and W(3) derived from the monomers M(1) and M(3) are present as at least monovalent salt, and
(d) optionally distilling the mixture obtained after step (c).

R¹, R², A, and B are as defined above.

Preferred examples of monomer M(3) are sodium styrene sulfonate or sodium vinyltoluene sulfonate.

Preferred examples of monomer M(4) are ethyl (meth)acrylate, butyl (meth)acrylate, phenyl, benzyl, naphthyl (meth)acrylate, and cardanyl (meth)acrylate, preferably cardanyl (meth)acrylate.

In step (a), the monomers M(1), M(2), M(3) and optionally M(4) are preferably mixed with water and/or organic solvents, e.g. C₂₋₈ alcohol, such as ethanol, glycerol or isopropanol, glycol, such as butyl diglycol, propylene glycol, dipropylene glycol, tripropylene glycol, glycol ester, ester, such as propylene glycol monomethyl ether acetate, ketone, such as acetone, and/or polyalkylene glycol, particularly polyethylene glycol such as PEG 100-600, preferably PEG 200-300, and propylene glycol, to yield a solution or a dispersion. The solution or dispersion can be produced by methods known to the skilled person, comprising, e.g., stirring or applying high shear forces.

Optionally, auxiliary agents such as surface-active reagents, particularly anionic and/or nonionic surfactants, can be employed to obtain a homogeneous and stable dispersion.

Preferably, the anionic surfactant comprises at least one phosphate, phosphonate, sulfate, sulfonate, carboxylate, sulfoacetate, sulfosuccinate and/or taurate group. In a further preferred embodiment, the anionic surfactant is selected from mono-, di-(C₄₋₂₂-alkyl(alkoxy)) phosphate, mono-, di-(C₄₋₂₂-alkyl) phosphonate, C₄₋₂₂-alkylaminophosphonate, C₄₋₂₂-alkyl(alkoxy)sulfate, secondary alkyl sulfonate, petroleum sulfonate, C₄₋₂₂-alkyl sulfonate, C₄₋₂₂-alkylarylsulfonate, fatty alcohol ether carboxylate, fatty acid salt, fatty alkyl sulfoacetate, fatty acid amide ether sulfate, fatty alcohol ether carboxylate, nonylphenol ether sulfate, fatty alkyl ether sulfate, C₄₋₂₂ alkyl polyalkoxylene phosphate, and C₄₋₂₂ alkyl polyalkoxylene sulfate.

The nonionic surfactant is preferably an alkoxylation product of fatty acid, fatty acid ester, fatty acid amine, fatty acid amide, fatty alcohol, aliphatic mono-, di- or tri-alcohol, mono-, di- or tri-glyceride, alkylphenol, sorbitan fatty acid and sugar derivatives or trialkylphenol polyalkoxylate or a block copolymer, e.g. poly(ethylene oxide-co-propylene oxide), selected from the group consisting of alkoxylated C₉-C₂₅ fatty alcohols, alkoxylated C₉-25 fatty acid amines, alkoxylated C₉-C₂₅ fatty acid amides, C₈-C₂₅ fatty acids alkoxylated at the carboxylate function, alkoxylated C₈-C₂₅ fatty acid esters, alkoxylated C₈-C₂₅ alkylphenols and alkoxylated mono-, di- or triglycerides of C₈-C₂₅ fatty acids and/or their esterification products with C₈-C₂₅ fatty acids or trialkylphenol polyalkoxylate or a block polymer, e.g. poly(ethylene oxide-co-propylene oxide), or fatty alcohol poly(ethylene oxide-co-propylene oxide) and mixtures thereof. The number of alkoxylene groups in the nonionic surfactant is at least 8, preferably 8-85, more preferably 10-85 and most preferably 10-80 repeating units. The alkyl groups can independently each be branched or straight-chain, saturated or unsaturated.

Preferably, 40-80 mol %, more preferably 40-70 mol %, more preferably 40-60 mol % or more preferably 50-70 mol % M(1), 5-50 mol %, more preferably 25-50 mol % or more preferably 10-40 mol % M(2), 1-20 mol %, more preferably 5-20 mol %, more preferably 7-20 mol % or 1-10 mol %, more preferably 1-8 mol % M(3) and 0-10 mol %, more preferably 0-5 mol % M(4) (with M(1)+M(2)+M(3)+optionally M(4)=100 mol %) are provided as solution or dispersion in step (a).

Accordingly, the molar ratio M(1):M(2):M(3):M(4) is preferably 9-20:1-12:0.1-3:0-3, more preferably 4-6:2.5-5:0.5-2:0-1.

The polymerization of the mixture obtained after step (a) in step (b) is preferably performed radically, particularly in the form of a radical solution polymerization. To this end, radical initiators are preferably used, such as inorganic persulfates, such as ammonium persulfate, potassium persulfate, sodium persulfate, hydroperoxides such as cumene hydroperoxide and tert-butyl hydroperoxide, dialkyl peroxides such as di-tert-butyl peroxide and dicumyl peroxide, peroxy esters such as tert-butyl perbenzoate, diacyl peroxide such as benzoyl peroxide and lauroyl peroxide, and azo compounds such as azobisobutyronitrile and azobisvaleronitrile. The weight proportion of radical initiator with respect to the total mass of the polymer is preferably 3-10 wt. %.

It is particularly preferred that a redox initiator system is used which comprises a combination of a reducing agent, e.g. sodium hypophosphite, sodium pyrosulfite, iron salt and/or ascorbic acid, and a peroxy compound. Such redox initiator systems ideally result in a short induction time and a homogeneous molar mass distribution.

Preferably, chain regulators such as hypophosphite and/or mercaptan, such as lauryl mercaptan, are also used in the polymerization before or during step (b). The use of chain regulators allows controlling the molecular weight of the polymer and the polydispersity. The chain regulators are preferably added in a proportion of 0.1-10 wt. %, more preferably 1-7 wt. % and most preferably 2-3.5 wt. % with respect to the total mass of the monomers.

Further, crosslinking agents such as triallylamine, divinylbenzene and glycidyl methacrylate can also be employed, preferably in a proportion of 0.1-12 wt. %, more preferably 0.1-6 wt. %, with respect to the total mass of the monomers.

The radical polymerization is preferably performed at elevated temperature, e.g. 30-100° C., preferably 30-80° C., preferably with stirring. The execution of a radical polymerization in solution or dispersion is known to the skilled person. Step (b) is typically completed when the residual monomer content is <5 wt. %, preferably <2 wt. %.

The polymerizate, particularly emulsion polymerizate or solution polymerizate, obtained after step (b) is subsequently neutralized. Neutralization is preferably performed with a base, particularly preferably with alkali hydroxide, such as sodium hydroxide and/or potassium hydroxide or alkaline earth hydroxide such as magnesium hydroxide, respectively, amine, ammonia or a mixture thereof.

At least 75 mol % of the repeating units W(1) and W(3) derived from the monomers M(1) and M(3) are present after neutralization as at least monovalent salt or in at least singly deprotonated form, respectively. The corresponding amount can either be calculated on the basis of the starting materials or can be adjusted via titration measurements.

It was surprisingly found that by adjusting the salt proportion of the repeating units W(1) and W(3) in the range of >75 mol %, more preferably in the range of 75-99.9 mol %, even more preferably in the range of 80-90 mol %, excellent substantivity is achieved and the viscosity of the composition is reduced compared to compositions in which less than 75 mol % of the repeating units W(1) and W(3) derived from the monomers M(1) and M(3) are present as salt. This enables excellent effects as well as easier processability and pumpability of the product.

In an optional step (d), water and/or organic solvent, particularly water and/or organic solvent with a boiling point of ≤100° C. at normal conditions, can be distilled off or removed from the mixture obtained after step (c). Typically, particularly organic solvents, particularly organic solvents with a boiling point of ≤100° C. at normal conditions, are removed. For concentrating or for providing the polymer as dry powder or granulate, the solvent used for the solution or dispersion, particularly water and/or organic solvent, can be partially or completely distilled off in step (d).

Preferably, after step (c) or (d), the composition has a solid content of 15-50 wt. %, preferably 25-40 wt. %, with respect to the total mass of the mixture obtained.

A further aspect of the invention relates to a polymer obtainable by the method described above. This polymer preferably has a pH value of 6-7, more preferably 6.2-6.5, measured in a 30% solution of the polymer in distilled water at 20° C. The solubility of the polymer at 20° C. in distilled water is preferably 100-600 g/L, more preferably 200-300 g/L.

The present invention also relates to a composition comprising
(A) at least one polymer according to the present invention,
(B) water and optionally a solvent such as C₂₋₈ alcohol, glycol, glycol ester, ester, ketone and/or polyalkylene glycol, particularly polyethylene glycol or polypropylene glycol, and
(C) optionally one or more additives, such as anionic and/or nonionic surfactant, UV stabilizer or salt, such as sodium sulfate, aluminum sulfate, zinc sulfate or magnesium sulfate and/or calcium chloride.

The salts mentioned in step (C) can further increase the substantivity of the polymers according to the invention, i.e., the affinity of the polymers to a substrate can be improved.

Preferably, the composition of the present invention comprises
(A) at least one polymer of the present invention,
(B) water and optionally an organic solvent such as ethanol, and
(C) optionally an additive.

The composition preferably comprises 15-50 wt. %, more preferably 25-40 wt. %, of component (A) with respect to the total weight of the composition.

The composition preferably has a viscosity of 50-1200 mPas, still further preferably 50-600 mPas, more preferably 100-300 mPas and most preferably 200-700 mPas at 20° C. measured according to DIN 53019/ISO 3219, e.g. measured with a Haake VT3R viscometer.

The composition preferably has a pH value in the range of 6-7, more preferably 6.2-6.5, at 20° C.

The composition can furthermore be diluted with solvent, for example with water. Preferably, the solid content of the polymer can be adjusted to 0.5-2 wt. % with respect to the total mass of the composition.

The polymer according to the invention or the composition according to the invention is excellently suited for improving the fastness, particularly the color fastness, e.g., perspiration, wash, light, water, and rub fastness, of substrates containing amide and/or amino groups. At the same time, the polymer according to the invention can also be advantageously employed as stain protection. The polymer is also suitable for the tanning or retanning of leather.

“Fastness,” particularly “color fastness,” is understood in the following as the resistance of dyed substrates to physical, chemical, and photochemical influences. “Color fastness” comprises water fastness, e.g., to salt water and chlorinated water, wash fastness, perspiration fastness, rub fastness, but also light fastness, i.e., the resistance to UV and daylight. Water and wash fastness refers to the resistance to salt water and chlorinated water as well as to washing at various temperatures in conventional suds. Wash fastness can be determined, for example, according to DIN EN ISO 105-C₀₆ A1S (40° C.). Water fastness can be tested, for example, according to DIN EN ISO 105-E01. For chlorinated bath water fastness, standardized tests according to DIN EN ISO 105-E03 can be used.

Perspiration resistance is understood as the resistance to human perspiration with its acidic and alkaline components. These can attack the dye and lead to decoloration or discoloration, respectively. Perspiration resistance can, for example, be measured according to DIN EN ISO 105-E04. Finally, rub resistance refers to the resistance to abrasion caused by mechanical stress.

The substrates containing amide or amino groups are preferably made of natural or synthetic materials, particularly wool, e.g., sheep's wool, cashmere, mohair, or goat hair, silk, polyamide, such as polyamide 6.0 and polyamide 6.6, polyamide mixtures, imitation leather, leather, or mixtures thereof. Suitable substrates for the present invention are preferably flexible substrates, such as textile substrates, imitation leather, or leather. In particular, the substrates are textiles, such as fibers, linear structures such as twine, threads, yarns, linen, cords, ropes, twisted yarns, (woven) fabrics, knitted fabrics, nonwoven fabrics, wadding, textile semi-finished and finished products, and finished goods made therefrom.

The textiles are used, for example, in the clothing industry, such as for sportswear, swimwear, and leisurewear; for home textiles, such as for carpets, curtains, upholstery fabrics, or for technical textiles, such as protective workwear.

In a further aspect, the present invention relates to a method for finishing substrates with a polymer according to the present invention or a composition of the present invention, comprising the steps of
(i) providing a polymer as described above in an aqueous solution or aqueous dispersion or a composition as described above,
(ii) applying the mixture of step (i) to a substrate, particularly a fiber, a fabric, a knitted fabric, a nonwoven fabric, a felt, a braided fabric, an imitation leather or leather, and
(iii) drying the product obtained after step (ii) at elevated temperature.

Preferably, the substrate is as described above.

The aqueous solution or aqueous dispersion in step (i) preferably contains water and optionally organic solvent such as C₂₋₈ alcohol, glycol, glycol ester, ester, ketone and/or polyalkylene glycol and preferably contains 0.1-2 wt. %, more preferably 0.2-1.5 wt. % and most preferably 0.6-1.2 wt. % polymer with respect to the total weight of the aqueous solution or aqueous dispersion or composition.

Typically, the pH value of the aqueous solution or dispersion in step (i) is between 3 and 6.5, preferably between 3 and 5.

The application of the mixture to a substrate is performed using methods known to the skilled person, such as by a spraying, foulard, dipping, exhaust, brushing, foam or slop padding process.

In the case of textile substrates, the polymer can be applied by application via forced application or exhaust process. Typically, in forced application, a liquor in the desired concentration is provided and is applied from an aqueous medium on the foulard via forced application with liquor pick-up of 40-100%.

The method is typically adjusted so that about 0.1-2 wt. %, preferably 0.1-1.5 wt. %, more preferably 0.3-1.2 wt. % of the polymer according to the invention is applied with respect to the dry weight of the substrate.

The drying of the obtained product according to step (iii) is preferably performed at 80-140° C., more preferably at 100-120° C.

A further aspect of the present invention is a fiber, a textile, an imitation leather or leather which is finished with a polymer of the present invention or a composition of the present invention or which has been produced by a method of the present invention.

The present invention is explained in more detail by means of the following examples, without being limited thereto:

### EXAMPLES

### Production Example 1

In a suitable four-neck flask equipped with a distillation condenser, adjustable stirrer, and internal thermometer, 43 g of water, 0.05 g of diethylenetriamine penta(methylen)phosphonic acid sodium salt, 5 g of sodium hypophosphite monohydrate, and 70 g of isopropanol are provided. After inerting several times with nitrogen, the flask is heated to reflux.

A solution containing 16.8 g of sodium styrene sulfonate (0.08 mol), 70.5 g of water, 82.5 g of isopropanol, 40.3 g of acrylic acid (0.56 mol), and 59.6 g of styrene (0.57 mol) is dosed into the four-neck flask within 4 hours. A solution of 8 g of sodium persulfate in 37 ml of water is also dosed into the four-neck flask within 5 hours. The solution is subsequently held at reflux for 1 hour. Thereafter, addition of 1.85 g of sodium persulfate in 41 g of water is performed and the solution is again held at reflux for 1 hour. The solution is subsequently cooled and 50% sodium hydroxide solution is added to achieve a neutralization degree of at least 75 mol %. Vacuum distillation is then performed to remove the isopropanol. Water is finally added to obtain a dry substance of approx. 30%.

### Production Example 2

In a suitable four-neck flask equipped with a distillation condenser, adjustable stirrer, and internal thermometer, 43 g of water, 0.05 g of diethylenetriamine penta (methylenephosphonic acid) sodium salt, 5 g of sodium hypophosphite monohydrate, and 70 g of isopropanol are provided. After inerting several times with nitrogen, the flask is heated to reflux.

A solution containing 16.5 g of sodium styrene sulfonate (0.08 mol), 70.5 g of water, 82.5 g of isopropanol, 39.8 g of acrylic acid (0.55 mol), 58.9 g of styrene (0.56 mol) and 6 g of Cardolite NX 2026 (0.02 mol) is dosed into the four-neck flask within 4 hours. A solution of 8 g of sodium persulfate in 37 ml of water is also dosed into the four-neck flask within 5 hours. The solution is subsequently held at reflux for 1 hour. Thereafter, addition of 1.85 g of sodium persulfate in 41 g of water is performed and the solution is again held at reflux for 1 hour. The solution is subsequently cooled and 50% sodium hydroxide solution is added to achieve a neutralization degree of at least 75 mol %. Vacuum distillation is then performed to remove the isopropanol. Water is finally added to obtain a dry substance of approx. 30%.

### Example 3: Application Technique

Polyamide 6.6 knitted fabric dyed with Acid Red 426 was post-treated with the preparations from Examples 1 and 2.

The post-treatment was performed in an exhaust process at a liquor ratio of 1:10 for 20 min at 70° C., employing the preparations from Examples 1 and 2 at 4% with respect to the article weight. The pH value was adjusted to 3 by means of a buffer system based on formic acid/sodium formate.

Determination of the wash fastness at 40° C. of the post-treated specimens was performed according to DIN EN ISO 105-C₀₆ A1S (40° C.) with multifibre adjacent fabric.

Assessment of the change in color was performed by means of a gray scale according to DIN EN 20102-A02.

To this end, the color of the textile samples was assessed on a scale of 5 to 1 based on the gray scale for color change. The scale ranges from 5 to 1, wherein 5 represents a negligible or no color change and 1 represents a significant color change. The results for the preparations from Examples 1 and 2 are listed below:

| Specimen | Color change |
|---|---|
| Not post-treated | 4 |
| Example 1 | 4-5 |
| Example 2 | 4-5 |

Assessment of staining was performed by means of a gray scale according to DIN EN ISO 105-A03.

To assess staining, the adjacent fabric treated in the test and an untreated adjacent fabric were placed side by side in a plane and compared with the gray scale. The scale ranges from 5 to 1, wherein a rating of 5 is only given if there is no difference between the adjacent fabric treated in the test and the untreated adjacent fabric. A rating of 1 represents a significant difference between treated and untreated adjacent fabric.

| Adjacent fabric | | | |
|---|---|---|---|
| (Multifibre) | Not post-treated | Example 1 | Example 2 |
| Cellulose acetate | 4 | 4-5 | 4-5 |
| Cotton | 1-2 | 3-4 | 3-4 |
| Polyamide 6.6 | 1 | 3-4 | 3-4 |
| Polyester | 4-5 | 4-5 | 4-5 |
| Polyacrylonitrile | 4-5 | 4-5 | 4-5 |
| Wool | 3-4 | 4-5 | 4-5 |

The preparations according to the invention of Examples 1 and 2 thus achieve an excellent wash fastness and prevent the staining of co-washed textiles.

### Comparative Example 1

In a suitable four-neck flask equipped with a distillation condenser, adjustable stirrer, and internal thermometer, 68.25 g of 99% ethanol, 21.75 g of deionized water, and 0.10 g of a 40% solution of the pentasodium salt of diethylenetriaminepentaacetic acid were provided. After repeated inerting with nitrogen, the flask was heated to reflux. A solution of 2.64 g of ammonium persulfate in 15 g of deionized water was added.

A solution containing 15 g of sodium styrene sulfonate (0.073 mol), 48.2 g of deionized water, 159.25 g of ethanol (99%), 112.5 g of 80% acrylic acid in deionized water (1.249 mol), and 45 g of styrene (0.432 mol) was dosed into the four-neck flask within 3 hours. A solution of 3.36 g of ammonium persulfate in 20 ml of deionized water was also dosed into the four-neck flask within 3.5 hours. The solution was subsequently held at reflux for 1 hour. The solution was subsequently cooled and a solution of 34.75 g of sodium hydroxide pellets in 150 g of deionized water was added. Vacuum distillation was then performed to remove ethanol. Deionized water was added to the flask to a net weight of 430 g.

This resulted in a dry substance of approx. 39%. The product is highly viscous.

After adjusting the dry substance to approx. 30%, a viscosity of 30,000 mPas and a pH value of 5.9 was obtained.

### Molar Ratios in the Polymer

Sodium styrene sulfonate: 4.16 mol %
Acrylic acid: 21.66 mol %
Sodium acrylate: 49.54 mol %
Styrene: 24.62 mol %

### Comparative Example 2

In a suitable four-neck flask equipped with a distillation condenser, adjustable stirrer, and internal thermometer, 68.25 g of 99% ethanol, 21.75 g of deionized water, and 0.10 g of a 40% solution of the pentasodium salt of diethylenetriaminepentaacetic acid were provided. After repeated inerting with nitrogen, the flask was heated to reflux. A solution of 2.64 g of ammonium persulfate in 15 g of deionized water was added.

A solution containing 3 g of sodium styrene sulfonate (0.015 mol), 49.72 g of deionized water, 159.25 g of 99% ethanol, 104.88 g of 80% acrylic acid in deionized water (1.164 mol), and 37.5 g of styrene (0.360 mol) was dosed into the four-neck flask within 3 hours. A solution of 3.36 g of ammonium persulfate in 20 ml of water was also dosed into the four-neck flask within 3.5 hours. The solution was subsequently held at reflux for 1 hour. The solution was subsequently cooled and a solution of 46.57 g of sodium hydroxide pellets in 150 g of deionized water was added. Vacuum distillation was then performed to remove ethanol. Deionized water was added to a net weight of 430 g.

This resulted in a dry substance of approx. 34%, a pH value of 7.7, and a viscosity of 400 mPas.

A production starting from sodium acrylate monomer is not possible. Deprotonation was therefore performed by addition of sodium hydroxide.

### Molar Ratios in the Polymer

Sodium styrene sulfonate: 0.97 mol %
Sodium acrylate: 75.63 mol %
Styrene: 23.40 mol %

### Comparative Example 3

In a suitable four-neck flask equipped with a distillation condenser, adjustable stirrer, and internal thermometer, 130 g of isopropanol and 35 g of deionized water were provided. After repeated inerting with nitrogen, the flask was heated to 80° C.

A solution containing 20.7 g of sodium styrene sulfonate (0.100 mol), 45 g of deionized water, 110 g of methacrylic acid (1.278 mol), and 19 g of butyl acrylate (0.148 mol) was dosed into the four-neck flask within approx. 2 hours. A solution of 16.6 g of sodium persulfate (0.069 mol) in 60 ml of deionized water was also dosed into the four-neck flask within approx. 2 hours. The solution was subsequently held at reflux for 1 hour. Subsequently, 500 g of deionized water was added to the solution. Vacuum distillation was then performed to remove isopropanol. Distillation was continued until an internal temperature of 99-100° C. was reached.

The dry substance of the specimen was approx. 20%, the viscosity was 350 mPas and the pure pH value was 1.3. The pH value of a 1% solution was 3.5.

### Molar Ratios in the Polymer

Sodium styrene sulfonate: 6.55 mol %
Methacrylic acid: 83.75 mol %
Butyl acrylate: 9.70 mol %

### Comparative Example 4

Starting from comparative example 3, butyl acrylate was replaced by styrene in equal quantities.

In a suitable four-neck flask equipped with a distillation condenser, adjustable stirrer, and internal thermometer, 130 g of isopropanol and 35 g of deionized water were provided. After repeated inerting with nitrogen, the flask was heated to 80° C.

A solution containing 20.7 g of sodium styrene sulfonate (0.100 mol), 45 g of deionized water, 110 g of methacrylic acid (1.278 mol), and 19 g of styrene (0.182 mol) was dosed into the four-neck flask within approximately 2 hours. A solution of 16.6 g of sodium persulfate (0.069 mol) in 60 ml of water was also dosed into the four-neck flask within 2 hours. The solution was subsequently held at reflux for 1 hour. Subsequently, 500 g of deionized water was added to the solution. Vacuum distillation was then performed to remove isopropanol. Distillation was continued until an internal temperature of 99-100° C. was reached.

The dry substance of the specimen was approx. 20%. The specimen was firm and no viscosity could be measured. The pH value was therefore determined for a 1% solution and was 3.5.

### Molar Ratios in the Polymer

Sodium styrene sulfonate: 6.41 mol %
Methacrylic acid: 81.92 mol %
Styrene: 11.67 mol %

### Application Technique of the Comparative Examples

The assessment of the color change was again performed by means of a gray scale according to DIN EN 20102-A02:

| Specimen | Color change |
|---|---|
| Not post-treated | 4 |
| Production example 1 | 4-5 |
| Comparative example 1 | 4 |
| Comparative example 2 | 4 |
| Comparative example 3 | 4 |
| Comparative example 4 | 4 |

Subsequently, polyamide 6.6 knitted fabric dyed with Acid Red 426 was post-treated with the polymerizates according to comparative examples 1-4. For this purpose, the solid content of the polymerizates was adjusted with deionized water. The pH value was adjusted to 3 in each case by means of a buffer system based on formic acid/sodium formate.

The post-treatment was performed in an exhaust process for 20 min at 70° C. The amount of each preparation used was 4% with respect to the article weight.

Determination of the wash fastness at 40° C. of the post-treated specimens was performed according to DIN EN ISO 105-C₀₆ A1S (40° C.) with multifibre adjacent fabric.

The assessment of staining was performed by means of a gray scale according to DIN EN ISO 105-A03.

To assess the staining, the adjacent fabric treated in the test and an untreated adjacent fabric were placed side by side in a plane and compared to the gray scale (see above).

| | Not | | | | | |
|---|---|---|---|---|---|---|
| Adjacent fabric | post- | Comparative | Comparative | Comparative | Comparative | Production |
| (Multifibre) | treated | example 1 | example 2 | example 3 | example 4 | example 1 |
| Cellulose | 4 | 4-5 | 4-5 | 4-5 | 4-5 | 4-5 |
| acetate | | | | | | |
| Cotton | 1-2 | 2-3 | 2-3 | 2 | 2 | 3-4 |
| Polyamide 6.6 | 1 | 2-3 | 2-3 | 2 | 2 | 3-4 |
| Polyester | 4-5 | 4-5 | 4-5 | 4-5 | 4-5 | 4-5 |
| Polyacrylonitrile | 4-5 | 4-5 | 4 | 4-5 | 4-5 | 4-5 |
| Wool | 3-4 | 4-5 | 4-5 | 4-5 | 4-5 | 4-5 |

It was found that on all fabrics tested, the composition according to the invention produces a significantly better color fastness, particularly wash fastness, than the comparative polymers.

The present invention comprises the following items:
1. A polymer comprising the repeating units

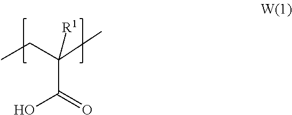

or a salt thereof,

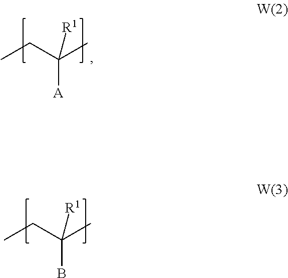

or a salt thereof,
   and optionally

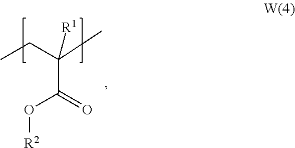

wherein
   R¹ is independently —H, -aryl or -alkyl, particularly —CH₃ or —C₂H₅, preferably H;
R² is independently —C₂₋₈-alkyl or
   -aryl optionally substituted with C₂₋₂₀-alkyl or C₂₋₂₀-alkenyl, or
   —CH₂—CH₂—O-aryl optionally substituted with C₂₋₂₀-alkyl or C₂₋₂₀-alkenyl, preferably -aryl;
   A is independently an aryl group, particularly -phenyl, -tolyl, -xylyl, or -naphthyl, particularly preferably phenyl,
   B is independently an aryl group, particularly -phenyl, -tolyl, -xylyl, or -naphthyl, particularly preferably phenyl, which is substituted with

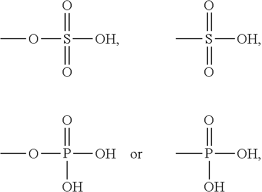

wherein at least 75 mol % of the repeating units W(1) and W(3) are present as at least monovalent salt, preferably as sodium salt.
2. The polymer of item 1, wherein the polymer contains 40-80 mol % W(1), 5-50 mol % W(2), 0.4-10 mol %, preferably 1-10 mol % W(3) and 0-10 mol % W(4).
3. The polymer of item 1 or 2, wherein the molar ratio is W(1) W(2) W(3):W(4)=9-20:1-12:0.1-3:0-3.
4. The polymer of any one of the preceding items, wherein R¹ is —H in each case, A is -phenyl in each case, and B is -substituted phenyl in each case.
5. The polymer of any one of the preceding items, wherein the polymer is soluble at 100-600 g/L in distilled water at 20° C.
6. The polymer of any one of the preceding items, wherein the pH value of a 30% solution in distilled water at 20° C. is 6-7, preferably 6.2-6.5, and/or the viscosity of a 30% solution in distilled water is 50-600 mPas, preferably 100-300 mPas at 20° C., measured according to DIN 53019/ISO 3219.
7. The polymer of any one of the preceding items, wherein the repeating units W(1), W(2), W(3) and optionally W(4) are arranged statistically, alternately or in blocks in the polymer chain.
8. A method for producing a polymer of any one of items 1-7, comprising the steps of
   (a) providing the monomers

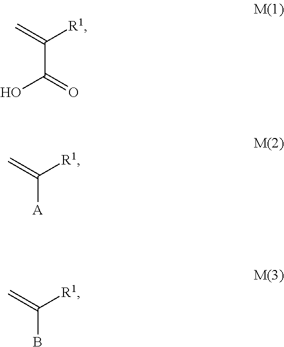

and optionally

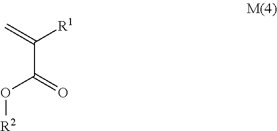

as solution or dispersion,
   (b) polymerizing the mixture obtained after step (a),
   (c) neutralizing the mixture obtained after step (b) so that at least 75 mol % of the repeating units W(1) and W(3) derived from the monomers M(1) and M(3) are present as at least monovalent salt, and
   (d) optionally distilling the mixture obtained after step (c).
9. The method of item 8, wherein in step (a) water and/or organic solvent, such as C₂₋₈ alcohol, glycol, glycol ester, ester, ketone and/or polyalkylene glycol, is used as solvent or dispersing agent.
10. The method of any one of items 8-9, wherein in step (a) 40-80 mol % M(1), 5-50 mol % M(2), 0.4-10 mol %, preferably 1-10 mol % M(3), 0-10 mol % M(4) are provided and/or the molar ratio is M(1):M(2):M(3):M(4)=9-20:1-12:0.1-3:0-3 in step (a).
11. The method of any one of items 8-10, wherein a radical polymerization is performed in step (b), preferably using radical initiators such as inorganic persulfates such as ammonium persulfate, potassium persulfate, sodium persulfate, hydroperoxides such as cumene hydroperoxide and tert-butyl hydroperoxide, dialkyl peroxides such as di-tert-butyl peroxide and dicumyl peroxide, peroxy esters such as tert-butyl perbenzoate, diacyl peroxide such as benzoyl peroxide and lauroyl peroxide, and azo compounds such as azobisisobutyronitrile and azobisvaleronitrile.
12. The method of item 11, wherein the radical initiator is a redox initiator system comprising a combination of a reducing agent, e.g. sodium hypophosphite, sodium pyrosulfite, iron salts and/or ascorbic acid, and a peroxy compound.
13. The method of any one of items 8-12, wherein chain regulators such as hypophosphite and/or mercaptan such as lauryl mercaptan are added before or during step (b).
14. The method of any one of items 8-13, wherein in step (c) a base, e.g. alkali hydroxide, alkaline earth hydroxide, amine, ammonia, preferably sodium hydroxide and/or potassium hydroxide, is added to the mixture obtained after step (b).
15. A polymer obtainable by a method according to any one of items 8-14.
16. The polymer of item 15, wherein the pH value of a 30% solution of the polymer in distilled water at 20° C. is 6-7, preferably 6.2-6.5, and/or the solubility of the polymer at 20° C. in distilled water is 100-600 g/L, preferably 200-300 g/L.
17. The polymer of any one of items 1-7 or 15-16, wherein the polymer contains 40-70 mol % W(1), 25-50 mol % W(2), 5-20 mol % W(3) and 0-10 mol % W(4), with the proviso that the polymer contains 30-70 mol %, preferably 35-70 mol %, preferably 40-70 mol %, repeating units of W(2) and W(3) (W(2)+W(3)).
18. A composition comprising
   (A) at least one polymer according to any one of items 1-7 or 15-17,
   (B) water and optionally a solvent such as C₂₋₈ alcohol, glycol, glycol ester, ester, ketone and/or polyalkylene glycol,
   (C) optionally one or more additives, such as anionic and/or nonionic surfactant, UV stabilizer or salt, such as sodium sulfate, aluminum sulfate, zinc sulfate or magnesium sulfate and/or calcium chloride.
19. The composition of item 18, comprising 15-50 wt. %, preferably 25-40 wt. %, of component (A) with respect to the total weight of the composition.
20. The composition of item 18 or 19, wherein the composition has a viscosity of 50-1200 mPas, preferably 200-700 mPas at 20° C., measured according to DIN 53019/ISO 3219.
21. The composition of any one of items 18-20, wherein the pH value of the composition is in the range of 6-7, preferably 6.2-6.5 at 20° C.
22. Use of the polymer according to any of items 1-7 or 15-17 or the composition according to any one of items 18-21 for improving the fastness, particularly the color fastness, e.g. perspiration, wash, light, water, and rub fastness of substrates containing amide and/or amino groups, as stain protection, preferably for carpets, and for tanning or retanning of leather.
23. The use according to item 22, wherein the substrates containing amide and/or amino groups are dyed and particularly comprise wool, silk, polyamide, such as polyamide 6.0 and polyamide 6.6, imitation leather, leather or mixtures thereof.
24. A method of finishing substrates with a polymer according to any one of items 1-7 or 15-17 or a composition according to any one of items 18-21 comprising the steps of:
   (i) providing a polymer according to any of items 1-7 or 15-17 in an aqueous solution or aqueous dispersion or a composition according to any of items 18-21,
   (ii) applying the mixture of step (i) to a substrate, particularly a fiber, a fabric, a knitted fabric, a nonwoven fabric, a felt, a braided fabric, an imitation leather or leather, and
   (iii) drying the product obtained after step (ii) at elevated temperature.
25. The method of item 24, wherein the aqueous solution or aqueous dispersion in step (i) contains water and optionally organic solvent such as C₂₋₈ alcohol, glycol, glycol ester, ester, ketone and/or polyalkylene glycol, and preferably contains 0.1-2 wt. %, more preferably 0.2-1.5 wt. % and most preferably 0.6-1.2 wt. % polymer with respect to the total weight of the aqueous solution or aqueous dispersion.
26. The method of item 24 or 25, wherein the application according to step (ii) is carried out by a spraying, foulard, dipping, exhaust, brushing, foam or slop padding process.
27. The method of any one of items 24-26, wherein step (iii) is performed at 80-140° C., preferably 100-120° C.
28. A fiber, textile, imitation leather or leather finished with a polymer according to any one of items 1-7 or 15-17 or with a composition according to any one of items 18-21 or obtainable by a method according to any one of items 24-27.

What is claimed is:

1. A polymer comprising the repeating units 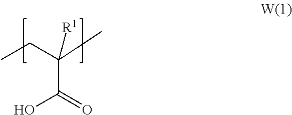
or a salt thereof, 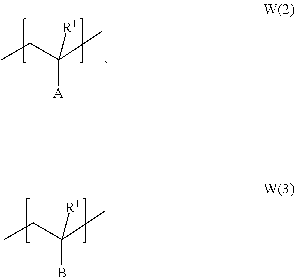
or a salt thereof,
and optionally 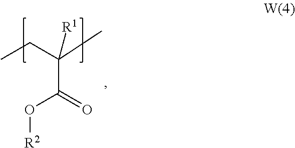
wherein
R¹ is independently —H, -aryl or -alkyl, particularly —CH₃ or —C₂H₅, preferably H;
R² is independently —C₂₋₈-alkyl or
-aryl optionally substituted with C₂₋₂₀-alkyl or C₂₋₂₀-alkenyl, or
—CH₂—CH₂—O-aryl optionally substituted with C₂₋₂₀-alkyl or C₂₋₂₀-alkenyl, preferably -aryl;
A is independently an aryl group, particularly -phenyl, -tolyl, -xylyl, or -naphthyl, particularly preferably phenyl,
B is independently an aryl group, particularly -phenyl, -tolyl, -xylyl, or -naphthyl, particularly preferably phenyl, which is substituted with 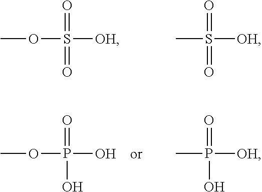
wherein at least 75 mol % of the repeating units W(1) and W(3) are present as at least monovalent salt, preferably as sodium salt,
wherein the polymer preferably contains 40-80 mol % W(1), 5-50 mol % W(2), 0.4-10 mol % W(3) and 0-10 mol % W(4) and/or
wherein the preferred molar ratio is W(1):W(2):W(3):W(4)-9-20:1-12:0.1-3:0-3.

2. The polymer of claim 1, wherein R¹ is —H in each case, A is -phenyl in each case, and B is -substituted phenyl in each case.

3. The polymer of claim 1, wherein the polymer is soluble at 100-600 g/L in distilled water at 20° C. and/or
wherein the pH value of a 30% solution in distilled water at 20° C. is 6-7, preferably 6.2-6.5, and/or
the viscosity of a 30% solution in distilled water is 50-600 mPas, preferably 100-300 mPas at 20° C., measured according to DIN 53019/ISO 3219.

4. A method for producing a polymer of claim 1, comprising the steps of
(a) providing the monomers 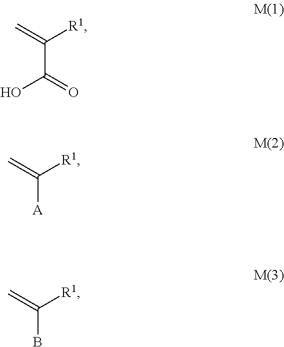
and optionally 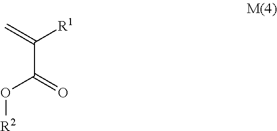
as solution or dispersion,
(b) polymerizing the mixture obtained after step (a),
(c) neutralizing the mixture obtained after step (b) so that at least 75 mol % of the repeating units W(1) and W(3) derived from the monomers M(1) and M(3) are present as at least monovalent salt, and
(d) optionally distilling the mixture obtained after step (c).

5. The method of claim 4, wherein in step (a) water and/or organic solvent, such as C₂₋₈ alcohol, glycol, glycol ester, ester, ketone and/or polyalkylene glycol, is used as solvent or dispersing agent, and/or
wherein in step (a) 40-80 mol % M(1), 5-50 mol % M(2), 0.4-10 mol % M(3), 0-10 mol % M(4) are provided and/or
the molar ratio is M(1):M(2):M(3):M(4)=9-20:1-12:0.1-3:0-3 in step (a).

6. The method of claim 4, wherein a radical polymerization is performed in step (b), preferably using radical initiators such as inorganic persulfates such as ammonium persulfate, potassium persulfate, sodium persulfate, hydroperoxides such as cumene hydroperoxide and tert-butyl hydroperoxide, dialkyl peroxides such as di-tert-butyl peroxide and dicumyl peroxide, peroxy esters such as tert-butyl perbenzoate, diacyl peroxide such as benzoyl peroxide and lauroyl peroxide, and azo compounds such as azobisisobutyronitrile and azobisvaleronitrile and/or
wherein the radical initiator is a redox initiator system comprising a combination of a reducing agent, e.g. sodium hypophosphite, sodium pyrosulfite, iron salts and/or ascorbic acid, and a peroxy compound.

7. The method of claim 4, wherein in step (c) a base, e.g. alkali hydroxide, alkaline earth hydroxide, amine, ammonia, preferably sodium hydroxide and/or potassium hydroxide, is added to the mixture obtained after step (b).

8. A polymer obtainable by a method according to claim 4.

9. A composition comprising
(A) at least one polymer according to claim 1,
(B) water and optionally a solvent such as C₂₋₈ alcohol, glycol, glycol ester, ester, ketone and/or polyalkylene glycol,
(C) optionally one or more additives, such as anionic and/or nonionic surfactant, UV stabilizer or salt, such as sodium sulfate, aluminum sulfate, zinc sulfate or magnesium sulfate and/or calcium chloride,
wherein the composition preferably comprises 15-50 wt. %, preferably 25-40 wt. %, of component (A) with respect to the total weight of the composition.

10. The composition of claim 9, wherein the composition has a viscosity of 50-600 mPas, preferably 100-300 mPas at 20° C., measured according to DIN 53019/ISO 3219 and/or
wherein the pH value of the composition is in the range of 6-7, preferably 6.2-6.5 at 20° C.

11. A method of using the polymer according to claim 1 for improving the fastness, particularly the color fastness, e.g. perspiration, wash, light, water, and rub fastness of substrates containing amide and/or amino groups,
wherein the substrates containing amide and/or amino groups are preferably dyed and particularly comprise wool, silk, polyamide, such as polyamide 6.0 and polyamide 6.6, imitation leather, leather or mixtures thereof.

12. A method of finishing substrates with a polymer according to claim 1, the method comprising the steps of:
(i) providing the polymer in an aqueous solution or aqueous dispersion,
(ii) applying the mixture of step (i) to a substrate, particularly a fiber, a fabric, a knitted fabric, a nonwoven fabric, a felt, a braided fabric, an imitation leather or leather, and
(iii) drying the product obtained after step (ii) at elevated temperature.

13. The method of claim 12, wherein the aqueous solution or aqueous dispersion in step (i) contains water and optionally organic solvent such as C₂₋₈ alcohol, glycol, glycol ester, ester, ketone and/or polyalkylene glycol, and preferably contains 0.2-2 wt. %, preferably 0.2-1.5 wt. %, preferably 0.6-1.2 wt. % polymer with respect to the total weight of the aqueous solution or aqueous dispersion.

14. The method of claim 12, wherein the application of step (ii) is carried out by a spraying, foulard, dipping, exhaust, brushing, foam or slop padding process.

15. A fiber, textile, imitation leather or leather finished with a polymer according to claim 1.
